(19) United States
(12) Patent Application Publication
(10) Pub. No.: US 2012/0039587 A1
(43) Pub. Date: Feb. 16, 2012

(54) HIGH-EFFICIENCY INFRARED RAY HEATING APPARATUS

(76) Inventor: Tomoyoshi Endo, Tokyo (JP)

(21) Appl. No.: 13/197,380

(22) Filed: Aug. 3, 2011

(30) Foreign Application Priority Data
Aug. 13, 2010 (JP) 2010-181245

(51) Int. Cl. H05B 1/00

(52) U.S. Cl. 392/422

(57) ABSTRACT

The present invention provides a novel high-efficiency infrared ray heating apparatus enabling concentrated heating of infrared rays to achieve high efficiency and seeking to reduce the size and weight to be usable on a desk, thereby achieving power saving. An infrared condensing side rotation reflector is connected to an infrared emission side rotation elliptic reflector. An infrared ray lamp is arranged in a focal position of the infrared emission side rotation elliptic reflector. The infrared emission side rotation elliptic reflector and the infrared condensing side rotation reflector are configured in such a shape that infrared rays reflected by the infrared emission side rotation elliptic reflector and the infrared condensing side rotation reflector are condensed with concentration on a tip small-diameter portion of the infrared condensing side rotation reflector. In some embodiments, a quartz rod focuses this infrared energy from the loop onto a specimen mounting stand.

### BACKGROUND OF THE INVENTION

The present invention relates to a high-efficiency infrared ray heating apparatus to heat a material such as a silicon wafer, ceramic, or metal in a vacuum, a magnetic field, or an atmosphere of various gases to a high temperature with great efficiency.

An infrared ray heating apparatus includes an infrared ray heating unit composed of an infrared emission side ½-rotation elliptic reflector and an infrared condensing side ½-rotation elliptic collector. An infrared ray lamp is arranged in a focal position of the infrared emission side ½-rotation elliptic reflector, an incidence unit of a cylindrical transparent quartz rod is arranged in the focal position of the infrared condensing side ½-rotation elliptic collector. A specimen mounting stand is arranged opposite to an emission unit of the cylindrical transparent quartz rod and is publicly known (for example, Japanese Patent No. 2517218).

The conventional technology of Japanese Patent No. 2517218 was developed and provided by the present patent applicant and can heat to a high temperature at high speed. However, the conventional technology cannot utilize a portion of infrared rays effectively, causing a problem of decreasing heating efficiency. Moreover, a relatively large infrared ray heating apparatus is heavy, posing a problem that the infrared ray heating apparatus cannot be used on a desk. In addition, the infrared ray heating apparatus requires high power. Further, emissive power of infrared rays is spread, which may make concentrated heating difficult depending on the size of a heated specimen.

In view of the above problems, the present invention provides a novel high-efficiency infrared ray heating apparatus enabling concentrated heating of infrared rays to achieve high efficiency and seeking to reduce the size and weight to be usable on a desk, thereby achieving power saving.

### SUMMARY OF THE INVENTION

Thus, in a high-efficiency infrared ray heating apparatus according to the present invention, an infrared condensing side rotation reflector is connected to an infrared emission side rotation elliptic reflector. An infrared ray lamp is arranged in a focal position F₁ of the infrared emission side rotation elliptic reflector, and the infrared emission side rotation elliptic reflector and the infrared condensing side rotation reflector are configured in such a shape that infrared rays reflected by the infrared emission side rotation elliptic reflector and the infrared condensing side rotation reflector are condensed with concentration on a tip small-diameter portion of the infrared condensing side rotation reflector.

Also, in the high-efficiency infrared ray heating apparatus according to the present invention, the shape combining the infrared emission side rotation elliptic reflector and the infrared condensing side rotation reflector is an inverted egg shape.

Also, in a high-efficiency infrared ray heating apparatus according to the present invention, an infrared condensing side rotation reflector is connected to an infrared emission side rotation elliptic reflector, an infrared ray lamp is arranged in a focal position F₁ of the infrared emission side rotation elliptic reflector. A conical transparent quartz rod is provided inside the infrared condensing side rotation reflector, a tip small-diameter portion of the conical transparent quartz rod is arranged toward an infrared emission side. A cylindrical transparent quartz rod of an identical diameter is integrally provided on the tip small-diameter portion of the conical transparent quartz rod or the conical transparent quartz rod and the cylindrical transparent quartz rod are provided separately to project from the infrared condensing side rotation reflector. A specimen mounting stand is arranged facing the tip of the projected cylindrical transparent quartz rod.

Also, in the high-efficiency infrared ray heating apparatus according to the present invention, a circumference of the conical transparent quartz rod is in close vicinity to or in contact with an inner surface of the infrared condensing side rotation reflector.

Further, in the high-efficiency infrared ray heating apparatus according to the present invention, the infrared condensing side rotation reflector is a conical reflector.

Also, in the high-efficiency infrared ray heating apparatus according to the present invention, a large-diameter side surface of the conical transparent quartz rod has a circular section.

In a high-efficiency infrared ray heating apparatus according to the present invention, an infrared condensing side rotation reflector is connected to an infrared emission side rotation elliptic reflector. An infrared ray lamp is arranged in a focal position of the infrared emission side rotation elliptic reflector, and the infrared emission side rotation elliptic reflector and the infrared condensing side rotation reflector are configured in such a shape that infrared rays reflected by the infrared emission side rotation elliptic reflector and the infrared condensing side rotation reflector are condensed with concentration on a tip small-diameter portion of the infrared condensing side rotation reflector. Therefore, infrared rays I₁, I₂, and I₃ inside the heating unit composed of the infrared emission side rotation elliptic reflector and the infrared condensing side rotation reflector are condensed with concentration to gain an effect of being able to provide infrared ray heating apparatus enabling concentrated heating of a specimen to achieve high efficiency. Moreover, an effect of being able to achieve size and weight reduction to be usable on a desk and also being able to save power is gained.

In a high-efficiency infrared ray heating apparatus according to the present invention, an infrared condensing side rotation reflector is connected to an infrared emission side rotation elliptic reflector, an infrared ray lamp is arranged in a focal position of the infrared emission side rotation elliptic reflector. A conical transparent quartz rod is provided inside the infrared condensing side rotation reflector. A tip small-diameter portion of the conical transparent quartz rod is arranged toward an infrared emission side. A cylindrical transparent quartz rod of an identical diameter is provided on the tip small-diameter portion of the conical transparent quartz rod integrally or separately from the conical transparent quartz rod to project from the infrared condensing side rotation reflector. A specimen mounting stand is arranged facing the tip of the projected cylindrical transparent quartz rod. Therefore, a large-diameter side incident surface of the conical transparent quartz rod takes in substantially all infrared rays I₁, I₂, and I₃ generated from the infrared ray lamp into the cylindrical transparent quartz rod. This introduces the infrared rays into the cylindrical transparent quartz rod provided on the conical transparent quartz rod integrally or separately with concentration so that an effect of being able to provide a very high-efficiency infrared ray heating apparatus is gained because infrared rays inside a transparent quartz rod is hardly attenuated. Moreover, high efficiency is gained and therefore, an effect of being able to achieve size and weight reduction as an apparatus and also being able to save power is gained.

These and other features, objects and advantages of the present invention will become apparent upon reading the following description thereof together with reference to the accompanying drawings.

### BRIEF DESCRIPTION OF THE DRAWINGS

FIG. 1 is a configuration explanatory view of a high-efficiency infrared ray heating apparatus according to the present invention;

FIG. 2 is a configuration explanatory view of the high-efficiency infrared ray heating apparatus according to the present invention in which an infrared condensing side rotation reflector is a conical reflector;

FIG. 3 is a configuration explanatory view of the high-efficiency infrared ray heating apparatus according to the present invention in which a large-diameter side surface of a conical transparent quartz rod has a circular section;

FIG. 4 is a configuration explanatory view of the high-efficiency infrared ray heating apparatus of a cylindrical transparent quartz rod;

FIG. 5 is a configuration explanatory view of the conical transparent quartz rod obtained by changing a tip of the cylindrical transparent quartz rod to a convex lens shape;

FIG. 6 is a configuration explanatory view of the high-efficiency infrared ray heating apparatus in which a specimen mounting stand is provided in a focal position of the infrared condensing side rotation reflector; and

FIG. 7 is a configuration explanatory view of the high-efficiency infrared ray heating apparatus in which the infrared condensing side rotation reflector is the conical reflector.

### DETAILED DESCRIPTION OF THE PREFERRED EMBODIMENT

Details of the present invention will be described based on the configuration explanatory views shown in drawings.

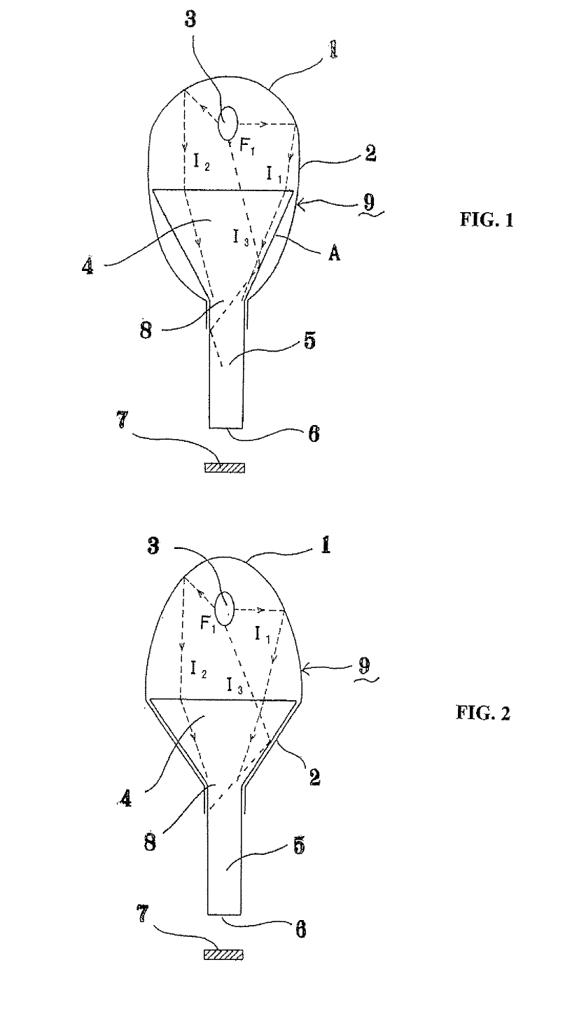

Reference numeral 1 in FIG. 1 is an infrared emission side rotation elliptic reflector. The infrared emission side rotation elliptic reflector 1 is connected to an infrared condensing side rotation reflector 2 to configure a heating unit 9. Like a heating unit of the publicly known infrared ray heating apparatus, the infrared emission side rotation elliptic reflector 1 and the infrared condensing side rotation reflector 2 are constituted by gold-plating an inner surface of the main body of a stainless material or the like and, though not illustrated, a water-cooling structure is provided on an outer side thereof.

Like a publicly known connection structure, though not illustrated, the connection of the infrared emission side rotation elliptic reflector 1 and the infrared condensing side rotation reflector 2 is constituted by providing a flange in each connection portion and removably screwing these flanges together.

In a high-efficiency infrared ray heating apparatus according to the present invention, as shown in FIG. 1, the infrared emission side rotation elliptic reflector 1 is configured in a shallow shape, the infrared condensing side rotation reflector 2 is configured in a deep shape, and as shown in, for example, a second aspect, a combined shape thereof is an inverted egg shape. The infrared rays I₁, I₂, and I₃ from an infrared ray lamp 3 in a focal position F₁ of the infrared emission side rotation elliptic reflector 1 are reflected by both reflectors to be condensed on a tip small-diameter portion 8 of a conical transparent quartz rod 4 of the infrared condensing side rotation reflector 2 with concentration.

The infrared ray lamp 3 is arranged in the focal position F₁ of the infrared emission side rotation elliptic reflector 1 and the conical transparent quartz rod 4 is provided inside the infrared condensing side rotation reflector 2. A circumference on a large-diameter side surface of the conical transparent quartz rod 4 is arranged in close vicinity to or in contact with the inner surface of the infrared condensing side rotation reflector 2. On the other hand, a cylindrical transparent quartz rod 5 having the same diameter as that of the tip small-diameter portion 8 is provided integrally or separately on the small-diameter portion of the conical transparent quartz rod 4. A cylindrical transparent quartz rod 5 projects from the infrared condensing side rotation reflector 2 to a specimen mounting stand 7 facing a tip 6, which is the infrared ray emission end of the rod 5.

A high-efficiency infrared ray heating apparatus according to the present invention has the conical transparent quartz rod 4 arranged inside the infrared condensing side rotation reflector 2 and thus, infrared rays generated from the infrared ray lamp 3 can be taken in with great efficiency and the infrared ray I₃ entering the conical transparent quartz rod 4 is totally reflected by an interface surface A with air so as to be condensed and introduced into the cylindrical transparent quartz rod 5. The infrared ray is hardly attenuated inside the transparent quartz rod so that the infrared ray heating apparatus can be made extremely efficient.

The configuration of an embodiment shown in FIG. 2 shown with the same reference numerals as those of the embodiment shown in FIG. 1 is similar to the configuration shown in FIG. 1. The configuration shown in FIG. 2 is characterized in that the infrared condensing side rotation reflector 2 is changed to, like the conical transparent quartz rod 4, a conical shape. Moreover, the infrared condensing side rotation reflector 2 in a conical shape is arranged in substantially close vicinity to the conical transparent quartz rod 4. Thus, infrared rays can be condensed into the cylindrical transparent quartz rod 5 more efficiently because infrared rays are hardly attenuated inside the transparent quartz rod.

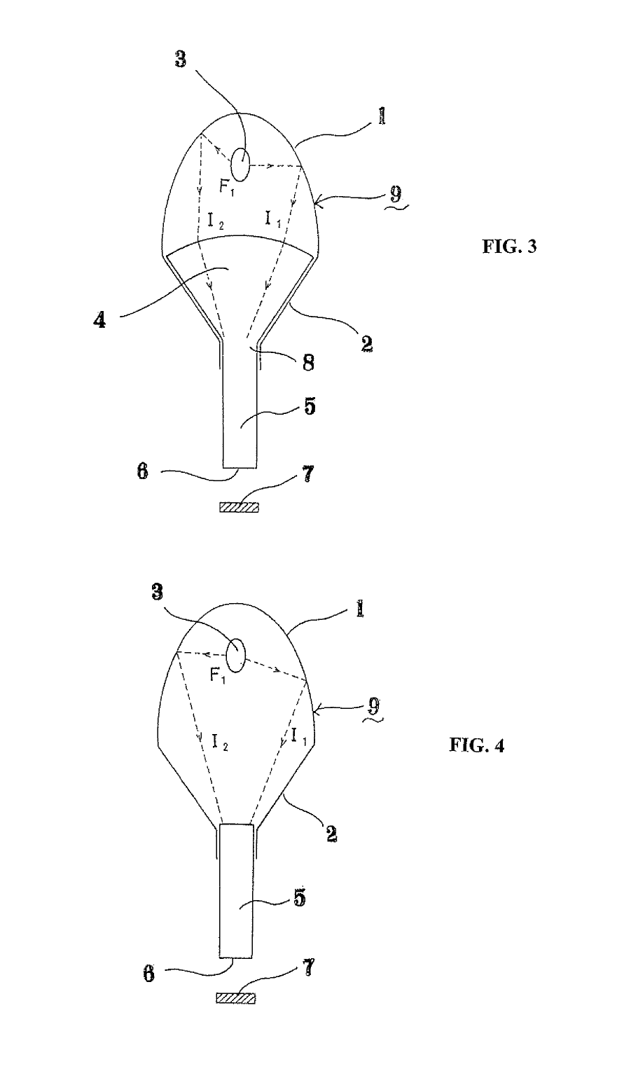

The configuration of an embodiment shown in FIG. 3 shown with the same reference numerals as those of the embodiment shown in FIG. 2 is similar to the configuration shown in FIG. 2 and is characterized in that the large-diameter side surface of the conical transparent quartz rod 4 has a circular section. With this configuration, infrared rays emitted from the infrared ray lamp 3 and reflected by the infrared emission side rotation elliptic reflector 1 are refracted satisfactorily by the surface of the circular section so that infrared rays can be condensed into the cylindrical transparent quartz rod 5 efficiently with more concentration because infrared rays are hardly attenuated inside the transparent quartz rod.

The configuration of an embodiment shown in FIG. 4 shown with the same reference numerals as those of the embodiment shown in FIG. 3 is similar to the configuration shown in FIG. 3. In this embodiment, the conical transparent quartz rod 4 is not provided and the cylindrical transparent quartz rod 5 is projected from the tip of infrared condensing side rotation reflector 2 in the conical shaped end.

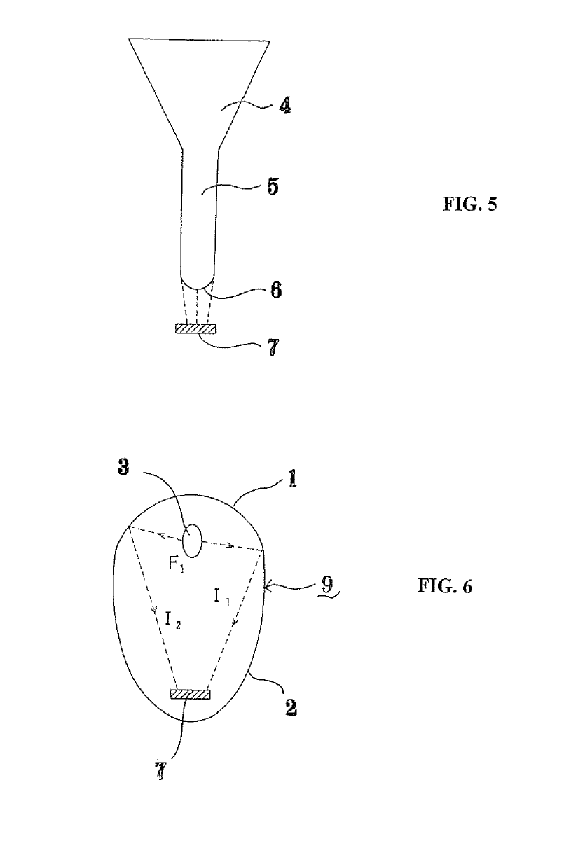

FIG. 5 shows the conical transparent quartz rod 4, the cylindrical transparent quartz rod 5, and the tip 6, which is an infrared ray emission end of the cylindrical transparent quartz rod 5. The tip 6 is configured in a convex lens shape to condense infrared emission light therefrom.

FIG. 6 shows an embodiment in which the specimen mounting stand 7 is provided in a condensing portion of infrared rays generated by the infrared ray lamp inside the heating unit 9. Unit 9 is composed of the infrared emission side rotation elliptic reflector 1 and the infrared condensing side rotation reflector 2, as shown in FIG. 1.

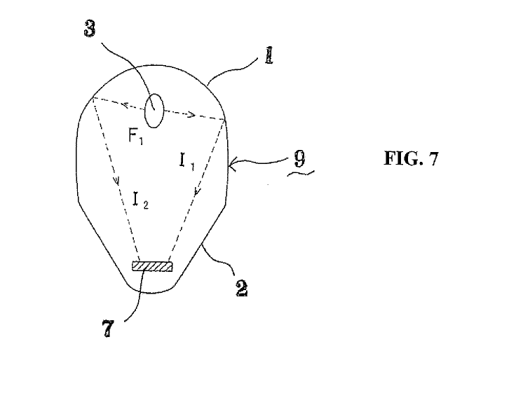

Similarly, FIG. 7 shows an embodiment having a similar configuration as shown in FIG. 6. In this embodiment, the infrared condensing side rotation reflector 2 is formed in a conical shape.

### EXPLANATIONS OF REFERENCE NUMERALS

1 Infrared emission side rotation elliptic reflector

2 Infrared condensing side rotation reflector

3 Infrared ray lamp

4 Conical transparent quarts rod

5 Cylindrical transparent quarts rod

6 Tip

7 Specimen mounting stand

8 Tip small-diameter portion of the conical transparent quarts rod

9 Heating unit

An interface surface

F₁ Focal point

I₁, I₂, I₃ Infrared ray

It will become apparent to those skilled in the art that various modifications to the preferred embodiment of the invention as described herein can be made without departing from the spirit or scope of the invention as defined by the appended claims.

The invention claimed is:

1. A high-efficiency infrared ray heating apparatus comprising:
an infrared emission side rotation elliptic reflector;
an infrared condensing side rotation reflector connected to the emission side reflector; and
an infrared ray lamp arranged at a focal position of the infrared emission side rotation elliptic reflector, wherein the infrared emission side rotation elliptic reflector and the infrared condensing side rotation reflector are configured such that infrared rays reflected by the infrared emission side rotation elliptic reflector and the infrared condensing side rotation reflector are condensed with concentration on the focal position of the infrared condensing side rotation reflector.

2. The high-efficiency infrared ray heating apparatus according to claim 1 wherein the shape of the infrared emission side rotation elliptic reflector and the infrared condensing side rotation reflector is an inverted egg shape.

3. The high-efficiency infrared ray heating apparatus according to claim 1 wherein the infrared condensing side rotation reflector is connected to the infrared emission side rotation elliptic reflector, the infrared ray lamp is arranged in the focal position of the infrared emission side rotation elliptic reflector, and a specimen mounting stand is arranged in the focal position of the infrared condensing side rotation reflector.

4. The high-efficiency infrared ray heating apparatus according to claim 2 wherein the infrared condensing side rotation reflector is connected to the infrared emission side rotation elliptic reflector, the infrared ray lamp is arranged in the focal position of the infrared emission side rotation elliptic reflector, and a specimen mounting stand is arranged in the focal position of the infrared condensing side rotation reflector.

5. The high-efficiency infrared ray heating apparatus according to claim 4 wherein the infrared condensing side rotation reflector is a conical reflector.

6. The high-efficiency infrared ray heating apparatus according to claim 3 wherein the infrared condensing side rotation reflector is a conical reflector.

7. A high-efficiency infrared ray heating apparatus comprising:
an infrared emission side rotation elliptic reflector;
an infrared ray lamp arranged at a focal position of the infrared emission side rotation elliptic reflector;
an infrared condensing side rotation reflector connected to said emission side reflector;
a conical transparent quartz rod positioned inside the infrared condensing side rotation reflector, a tip small-diameter portion of the conical transparent quartz rod arranged toward an infrared condensing side;
a cylindrical transparent quartz rod of an identical diameter provided on the tip small-diameter portion of the conical transparent quartz rod integrally or separately from the conical transparent quartz rod to project from the infrared condensing side rotation reflector; and
a specimen mounting stand arranged facing the tip of the projected cylindrical transparent quartz rod.

8. The high-efficiency infrared ray heating apparatus according to claim 7 wherein the infrared condensing side rotation reflector is a conical reflector.

9. The high-efficiency infrared ray heating apparatus according to claim 7 wherein the circumference of the conical transparent quartz rod is in close vicinity to or in contact with an inner surface of the infrared condensing side rotation reflector.

10. The high-efficiency infrared ray heating apparatus according to claim 7 wherein a large-diameter side surface of the conical transparent quartz rod has a circular section.

11. The high-efficiency infrared ray heating apparatus according to claim 9 wherein the infrared condensing side rotation reflector is a conical reflector.

12. The high-efficiency infrared ray heating apparatus according to claim 11 wherein the circular section of the transparent quartz rod is formed in a convex lens shape.

13. The high-efficiency infrared ray heating apparatus according to claim 8 wherein a large-diameter side surface of the conical transparent quartz rod has a circular section.

14. The high-efficiency infrared ray heating apparatus according to claim 13 wherein the circular section of the transparent quartz rod is formed in a convex lens shape.

15. The high-efficiency infrared ray heating apparatus according to claim 9 wherein a large-diameter side surface of the conical transparent quartz rod has a circular section.

16. The high-efficiency infrared ray heating apparatus according to claim 15, wherein the circular section of the transparent quartz rod is formed in a convex lens shape.

17. A high-efficiency infrared ray heating apparatus comprising:
an infrared emission side rotation elliptic reflector;
an infrared ray lamp arranged at a focal position of the infrared emission side rotation elliptic reflector;
an infrared condensing side rotation reflector connected to said emission side reflector;
a cylindrical transparent quartz rod projects from the infrared condensing side rotation reflector; and
a specimen mounting stand arranged facing a tip of the projected cylindrical transparent quartz rod.

18. The high-efficiency infrared ray heating apparatus according to claim 17 wherein the tip of the cylindrical transparent quartz rod is formed in a convex lens shape.
